(19) United States
(12) Patent Application Publication
(10) Pub. No.: US 2020/0387711 A1
(43) Pub. Date: Dec. 10, 2020

(54) INDOOR AUGMENTED REALITY INFORMATION DISPLAY METHOD

(71) Applicant: YUTOU TECHNOLOGY (HANGZHOU) CO., LTD., Hangzhou City (CN)

(72) Inventors: Cheng LU, Hangzhou City (CN); Yiming CHEN, Hangzhou City (CN); Zhiyu HUO, Hangzhou City (CN)

(21) Appl. No.: 16/895,724

(22) Filed: Jun. 8, 2020

(30) Foreign Application Priority Data
Jun. 6, 2019 (CN) 201910492386.5

(51) Int. Cl. G06K 9/00; H04W 4/33; H04W 4/80; G02B 27/01

(52) U.S. Cl. CPC G06K 9/00671; H04W 4/33; G02B 2027/0178; G02B 27/0172; H04W 4/80

(57) ABSTRACT

The present invention relates to an indoor augmented reality information display method, system and terminal. The method comprises the steps: acquiring position information of a first target; and if a matching degree of the position information of the first target and preset position information is more than a preset threshold, acquiring information from an information database, and displaying the information. By using the indoor augmented reality information display method, system and terminal provided by the present invention, the position information of the first target can be automatically acquired, so that data collection time and cost are saved, and efficiency is improved; value-added service is provided by fully using positioning information; and meanwhile, the information is displayed only after a corresponding condition is met, so that information display accuracy is improved, and thus wrong information is prevented from being displayed, and user experience is further enhanced.

### FIELD

The present invention relates to the technical field of augmented reality, and in particular relates to an indoor augmented reality information display method.

### BACKGROUND

In the prior art, no indoor augmented reality information display method is provided, a part of applications carries out some simple positioning according to indoor Wifi signals, but following problems exist in the prior art:

(1) a user needs to actively log in an application, and thus operation is tedious;
(2) positioning accuracy is not high, and user experience is poor; and
(3) value-added service is not provided by using positioning information.

Therefore, in order to facilitate user operation, save operation time, improve positioning precision, enhance user experience, and meanwhile, be able to provide value-added service by fully utilizing the positioning information, an indoor augmented reality information display method needs to be provided urgently.

### SUMMARY

The present invention aims at providing an indoor augmented reality information display method, system and terminal, which achieve the purpose of displaying relevant position information content through acquiring positioning information indoors, and can save data collection time and cost, improve efficiency, and provide value-added service by fully utilizing positioning information; and meanwhile, the information is displayed only after a corresponding condition is met, so that information display accuracy is improved, and thus wrong information is prevented from being displayed, and user experience is further enhanced.

The purpose of the present invention is achieved by using the following technical solution. The indoor augmented reality information display method provided by the present invention comprises the following steps: acquiring position information of a first target; and if a matching degree of the first target position information and preset position information is more than a preset threshold, acquiring information from an information database, and displaying the information.

The purpose of the present invention can also be further achieved by using the following technical solution.

In the indoor augmented reality information display method mentioned above, the step of acquiring the position information of the first target comprises the sub-steps: collecting first signals within a preset range of the first target; and if the first signals meet a first condition, determining the position information of the first target.

In the indoor augmented reality information display method mentioned above, the step of collecting the first signals within the preset range of the first target adopts a wireless signal fingerprint method; and when building a map, the wireless signal fingerprint method comprises the steps: performing data collection and system deployment within a preset range; and calculating to acquire position information within the preset range; wherein the data collection and system deployment adopts a robot-based mode or a crowdsourcing-based mode.

In the indoor augmented reality information display method mentioned above, when the first signals do not meet the first condition, second signals within the preset range of the first target are collected, wherein the position information of the first target is determined after the second signals are fused with the first signals.

In the indoor augmented reality information display method mentioned above, the first signals are wireless signals, and the second signals are visual signals; or the first signals are visual signals, and the second signals are wireless signals.

In the indoor augmented reality information display method mentioned above, the step of collecting the visual signals within the preset range of the first target comprises the sub-steps: determining a second target within the preset range; and storing position information of the second target, wherein the position information of the second target comprises at least one of a relative distance and a relative angle between the second target and the first target.

In the indoor augmented reality information display method mentioned above, the wireless signals are at least one kind of the following signals: Wireless Fidelity signals, Bluetooth signals and inertial sensor signals.

In the indoor augmented reality information display method mentioned above, the visual signals are visual scene signals and/or sign signals.

The indoor augmented reality information display method mentioned above also comprises the step of calculating the matching degree of the first target position information and the preset position information, before the step of acquiring information from an information database, if the matching degree of the first target position information and preset position information is more than the preset threshold, and displaying the information.

In the indoor augmented reality information display method mentioned above, the step of calculating the matching degree of the first target position information and the preset position information comprises the sub-steps: sending the position information of the first target to a server; and calculating the matching degree of the first target position information and the preset position information. Or the step of calculating the matching degree of the first target position information and the preset position information comprises the sub-steps: sending a request instruction to a server, wherein the request instruction is used for requesting the server to send the preset position information; receiving the preset position information sent by the server; and calculating the matching degree of the first target position information and the preset position information.

In the indoor augmented reality information display method mentioned above, the step of displaying the information comprises the sub-steps: acquiring a position attribute parameter in the first target position information; and if similarity between the position attribute parameter and a preset position attribute parameter is more than a threshold, displaying the preset information.

The indoor augmented reality information display method mentioned above is characterized in that the position attribute parameter comprises a three-dimensional coordinate value of the first target; and/or the degrees of included angles between the first target and a three-dimensional space coordinate axes, wherein the position attribute parameter and the preset position attribute parameter adopt a same coordinate system.

The purpose of the present invention is also achieved by using the following technical solution. The method for building an information database provided by the present invention comprises the following steps: respectively collecting and storing position information and content information of a second target; and associating the position information with the content information.

The purpose of the present invention can also be further achieved by using the following technical solution.

The method for building the information database mentioned above also comprises the steps of updating the position information of the second target; and/or updating the content information of the second target, after the step of associating the position information with the content information.

In the method for building the information database mentioned above, the step of collecting and storing the position information of the second target comprises the sub-steps: reading a position map including the second target; acquiring the position information of the second target; and storing the position information of the second target, wherein the position information of the second target is editable after being stored.

The purpose of the present invention is also achieved by using the following technical solution. An indoor augmented reality information display system provided by the present invention comprises a module for executing steps of the indoor augmented reality information display method as described in any of said claims; and/or a module for executing steps of the method for building the information database as described in any of said claims.

The purpose of the present invention is also achieved by using the following technical solution. According to a computer readable storage medium in which a computer program is stored provided by the present invention, when the program is executed, the indoor augmented reality information display method as described in any of said claims is implemented; and/or when the program is executed, the method for building the information database as described in any of said claims is implemented.

The purpose of the present invention is also achieved by using the following technical solution. A terminal provided by the present invention comprises a memory, a processor and a computer program that is stored in the memory and can run on the processor, wherein when the processor executes the computer program, the indoor augmented reality information display method as described in any of said claims is implemented; and/or when the processor executes the program, the method for building the information database as described in any of said claims is implemented.

Compared with the prior art, the present invention has obvious advantages and beneficial effects. By means of the technical solutions, the indoor augmented reality information display method, system and equipment provided by the present invention at least have the following advantages and beneficial effects:

1, the position information of the first target can be automatically acquired without active operation of a user, so that data collection time and cost are saved, and efficiency is improved;

2, the information is displayed only after the corresponding condition is met, so that information display accuracy is improved, wrong information is prevented from being displayed, and user experience is further improved; and

3, augmented reality information display is carried out, and value-added service is provided for the user.

The description above is merely a summary of the technical solutions of the present invention, and may be implemented in accordance with the content of the specification in order to understand the technical means of the present invention more clearly; and in order to enable the above-mentioned and other objects, features, and advantages of the present invention to be more easily understood, the detailed description of preferred embodiments, taken in combination with the drawings, is set forth below.

### BRIEF DESCRIPTION OF THE DRAWINGS

FIG. 1 is a flow block diagram of an indoor augmented reality information display method provided by one embodiment of the present invention;

FIG. 2 is a flow block diagram of an indoor augmented reality information display method provided by one embodiment of the present invention;

FIG. 3 is a flow block diagram of an indoor augmented reality information display method provided by one embodiment of the present invention;

FIG. 4 is a flow block diagram of an indoor augmented reality information display method provided by one embodiment of the present invention;

FIG. 5 is a flow block diagram of an indoor augmented reality information display method provided by one embodiment of the present invention;

FIG. 6 is a flow block diagram of an indoor augmented reality information display method provided by one embodiment of the present invention;

FIG. 7 is a flow block diagram of an indoor augmented reality information display method provided by one embodiment of the present invention;

FIG. 8 is a flow block diagram of an indoor augmented reality information display method provided by one embodiment of the present invention;

FIG. 9 is a flow block diagram of a method for building an information database provided by one embodiment of the present invention;

FIG. 10 is a flow block diagram of a method for building an information database provided by one embodiment of the present invention;

FIG. 11 is a flow block diagram of a method for building an information database provided by one embodiment of the present invention;

FIG. 12 is a structure diagram of equipment provided by one embodiment of the present invention;

FIG. 13 is a flow diagram of one embodiment of the present invention; and

FIG. 14 is a flow diagram of one embodiment of the present invention.

Names and marking numbers of components in FIG. 1-FIG. 14 are as follows:
terminal 10000, memory 11000, computer program 11100 and processor 12000.

### DETAILED DESCRIPTION OF THE EMBODIMENTS

In order to further illustrate technical means and efficacy of the present invention for achieving a predetermined inventive purpose, detailed descriptions of specific embodiments, structures, features and efficacy of the indoor augmented information display method, system and equipment provided by the present invention are set forth below in combination with the drawings and preferred embodiments.

Although each embodiment represents a single combination of application steps, the steps of different embodiments of the present invention may be replaced, or combined, and thus the present invention may also be considered to comprise all possible combinations of steps in the same and/or different embodiments recited. Thus, if one embodiment comprises steps A, B, C and another embodiment comprises a combination of steps B and D, the present invention is also considered to comprise embodiments of all other possible combinations of one or more of steps A, B, C and D, although such embodiments may not be expressly written in the following.

The indoor augmented information display method provided by the embodiment of the present invention will be further described in detail below in combination with the drawings. FIG. 1 is the flow block diagram of the indoor augmented reality information display method provided by one embodiment of the present invention. Referring to FIG. 1, the indoor augmented information display method provided by the embodiment of the present invention mainly comprises the following steps:

S100, acquiring position information of a first target, wherein the first target refers to mobile equipment which may be augmented reality glasses (otherwise known as AR glasses, smart glasses) or other augmented reality equipment (otherwise known as AR equipment), virtual reality equipment (otherwise known as AR equipment), a mobile computer, a smart phone, a smart watch or other wearable equipment, a navigation device, or other equipment capable of collecting position information data.

It should be understood by those skilled in the art that the first target mentioned above may itself have a function of acquiring position information, or may acquire position information by means of other equipment, and as long as the equipment is movable, it should be within the scope of protection of the present invention.

The position information refers to the position information of the first target, and optionally, the position information refers to longitude and latitude values of the first target; optionally, the position information refers to the relative position of the first target relative to a preset space coordinate system; and optionally, the position information refers to the degrees of included angles between the first target and different coordinate axes in the preset space coordinate system. In some embodiments, the included angles refer to included angles between a camera in terminal equipment and different coordinate axes in the preset space coordinate system.

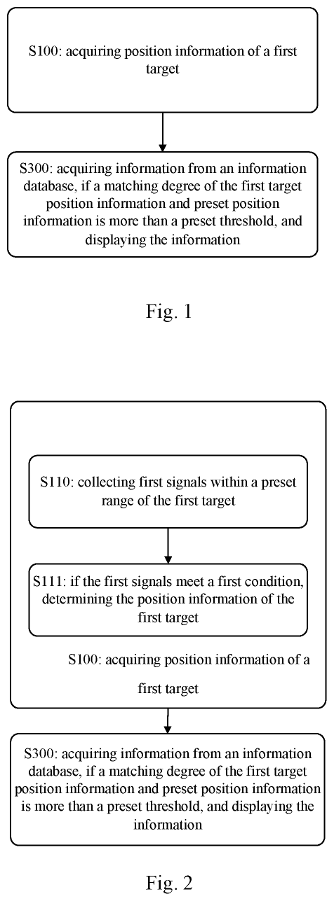

In some embodiments, referring to FIG. 2, the step S100 mentioned above specifically comprises the sub-steps:

S110, collecting first signals within a preset range of the first target, wherein the preset range is a range set in advance, optionally, the preset range is within a certain distance range, optionally, the preset range is within a certain angle range, and may also be within a certain angle range within a certain distance.

It should be understood by those skilled in the art that the preset range may be set in advance or may also be updated in real time according to an environment where the first target is located.

In some embodiments, the first signals are wireless signals, wherein the wireless signals may be Wireless Fidelity signals (otherwise known as Wi-Fi signal), Bluetooth signals, Zigbee signals, inertial sensor signals, GPS signals, RFID infrared signals or any other wireless signals. Optionally, data of the wireless signal mentioned above comprises wireless signal strength information, such as received signal strength indication (RSSI for short). In some embodiments, the first signals are visual signals, wherein the visual signals are scenes/signs in a visual range.

Optionally, the scene or sign mentioned above is a scene or object selected indoors, generally a symbolic scene or object, which may be one or more.

When the first signals within the preset range of the first target are collected, under the condition that there are many scenes or signs, images of the plurality of scenes or signs can be collected at each collection point. Optionally, feature points of the collected images can also be calculated and recorded.

Specifically, for example, when the indoor place is a shopping mall, the optional above-mentioned scenes or signs are logos on the tops of stores, and the optional above-mentioned scenes or signs are some easily recognizable scenes/signs on walkways of the shopping mall, such as a women's dress area, a men's dress area or a children's area.

It should be understood by those skilled in the art that wireless signal strength at a same location indoors may be affected by factors such as place environment structure, layout, and people density; the people density in a day may vary significantly in many places, particularly in public places, so that a wireless signal strength value may differ at different times. In addition, image data of the place is always changed along with time. Therefore, according to the present invention, richer and more accurate information can be acquired through collecting the data in multiple time periods, and later research and development are facilitated.

When the first signals are wireless signals, in some embodiments, the step S110: collecting the first signals within the preset range of the first target adopts a wireless signal fingerprint method. When building a map, the wireless signal fingerprint method comprises the steps: performing data collection and system deployment within a preset range; and calculating to acquire position information within the preset range;

The method based on wireless signal fingerprints is a popular method in a wireless signal positioning system, and achieves the balance between deployment cost and positioning accuracy. An indoor positioning method and a navigation method are implemented mainly based on the wireless signal fingerprints. The basic approach is as follows: in an early data collection stage, a series of key points which are dense enough are selected in an indoor place, wireless signal information is collected at all the key points, and mapping between wireless signals and the positions of the key points (namely the wireless signal fingerprints mentioned above) is established to form a mapped database; and in subsequent positioning and navigation stages, when the user wears the mobile equipment in an indoor place and the mobile equipment receives the wireless signal, the currently received wireless signal is matched with the collected wireless signals in the database through an algorithm by using the mapping database, to find the most similar wireless signal under a certain standard, and thus the position corresponding to the matched signal in the database is fed back to the mobile equipment as the specific position of the current mobile equipment. The wireless signals are fast in scanning speed and low in power consumption, and the dimensionality of wireless signal data is less than that of image data, so that a wireless signal positioning algorithm is extremely short in consumed time (positioning of scanning the signals at a time is on the order of a few milliseconds), and thus power consumption is low.

In some embodiments, data collection and system deployment adopt the crowdsourcing-based mode;

wherein adopting a crowdsourcing-based mode refers to that a staff walks in the place while wearing augmented reality glasses, or carrying a mobile phone or other equipment that can use an SLAM technology, and SLAM software in the equipment can automatically map the place and acquire coordinates of the collection points. Compared with the mode of enabling the staff to walk in the place while carrying the mobile equipment with the SLAM software to acquire the coordinates of the collection points, the mode of using a robot is reduced in human input, saved in mapping and collection point coordinate extraction time and lowered in cost; and movement of the robot is more accurate and controllable, and the acquired coordinate values are more accurate than those acquired by using the method of enabling the staff to walk.

Specifically, implementation in the crowdsoucing mode refers to that any one can download, install and use an application to help data collection. A positioning navigation data collection method provided by the present invention can also be implemented in an outsourcing mode. Under the outsourcing mode, the application is firstly installed on mobile equipment, and then some persons are employed to collect data by using the application. The crowdsoucing mode and the outsourcing mode can be a multi-user parallel collection mode, which can greatly reduce collection time, greatly lower cost, and improve efficiency. In addition, the crowdsoucing mode is also applicable to updating positioning navigation data of a small quantity of collection points.

In some embodiments, data collection and system deployment adopt a robot-based mode; wherein the robot-based mode refers to that a SLAM-based robot system is used for automatically mapping the place to acquire coordinate information of collection points. Compared with the mode of enabling the staff to walk in the place while carrying the mobile equipment with the SLAM software to acquire the coordinates of the collection points, the mode of using the robot is reduced in human input, saved in mapping and collection point coordinate extraction time and lowered in cost; and movement of the robot is more accurate and controllable, and the acquired coordinate values are more accurate than those acquired by using the method of enabling the staff to walk.

S111: if the first signals meet a first condition, determining the position information of the first target,

wherein the first condition is preset according to the type of the first signal.

For example, when the first signals are wireless signals, the optional first condition refers to that whether the current wireless signal is a specific wireless signal type or not, the optional first condition refers to that whether the current wireless signal meets a certain strength requirement, and the optional first condition refers to that whether the current wireless signal is within a certain band range.

When the first signals re visual signals, the optional first condition refers to that whether the current visual signal is the same as a preset visual signal or not, and the optional first condition refers to that whether similarity between the current visual signal and the preset visual signal reaches a preset threshold.

It should be understood by those skilled in the art that no matter what the first signals are and what the first condition is, methods that can determine the position information of the first target only after the first signals meet the first condition should be within the scope of protection of the present invention.

Explanations regarding the first target, the preset range, the wireless signals, the visual signals, and the first condition in the embodiments described above are also applicable to the following embodiments, and are not described in detail.

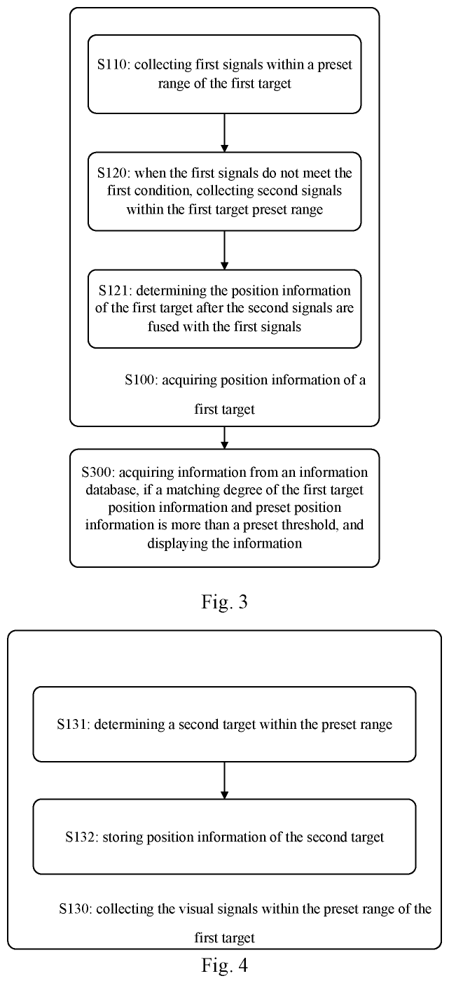

In some embodiments, referring to FIG. 3, the step S100 mentioned above specifically comprises the sub-steps:

S110, collecting first signals within a preset range of the first target,

S120, when the first signals do not meet the first condition, collecting second signals within the first target preset range;

wherein the second signals refer to the signals different from the first signals; optionally, when the first signals are wireless signals, the second signals are visual signals; and optionally, when the first signals are visual signals, the second signals are wireless signals. It should be understood by those skilled in the art that the second signals and the first signals can also refer to two different types of signals in wireless signals; and of course, the second signals and the first signals can also be scene signals and sign signals in the visual signals. they should be within the scope of protection of the present invention as long as the first signals are different from the second signals.

S121: determining the position information of the first target after the second signals are fused with the first signals,

wherein fusion refers to that the second signals play a role in correcting/supplementing the first signals. Correction aims at the situation that the first signals have wrong signals, such as nonuniform accuracy, nonuniform signal unit and wrong determination of a signal source; supplement aims at the situation that in the first signals, no signal is wrong, and the second signals further supplement the first signals, so that the position information is further determined, and thus the more accurate position information is acquired.

It should be understood by those skilled in the art that the combination of wireless signal positioning and visual signal positioning can greatly improve algorithm efficiency and reduce power consumption. A great time consuming point of visual signal positioning is that an algorithm needs to match a scene most similar to a scene observed by a current camera from a huge visual database. If there is no priori information, the algorithm needs to match the entire database, which is very time-consuming. And if wireless signal positioning is added, the wireless positioning can narrow a position range of the user/camera in advance, and then the vision algorithm only needs to match the existing visual scenes/signs in the narrowed position range. Therefore, the number of visual objects to be matched can be greatly reduced, and thus algorithm efficiency is greatly improved, and power consumption is reduced. More importantly, the wireless positioning can help to better improve accuracy of the vision algorithm, because wireless positioning prevents the vision algorithm from mismatching to visual objects outside the narrowed position range.

In the embodiments mentioned above, when the first signals are visual signals, referring to FIG. 4, the step S130: collecting the visual signals within the preset range of the first target comprises the sub-steps:

S131, determining a second target within the preset range,

wherein determination is to set one or more objects to be the second target(s) via an algorithm or calculation after multiple pieces of object information are collected within the preset range; of course, determination can also be to directly set one or more objects in the preset range to be the second target(s) via the algorithm or calculation and then collect corresponding object information,

wherein the second target is the object different from the first target; optionally, there may be one second target; and optionally, there may be many second targets. The second target is any target that the user may be interested in. In one or more embodiments, in the scene of a shopping mall, when the first target is the AR glasses, the second targets may be logos of stores, or direction boards of the shopping mall, or discount information of commodities.

S132: storing position information of the second target.

It should be understood by those skilled in the art that, no matter the position information is saved locally or in a server or other medium in which storage may be implemented, it should be within the scope of protection of the present invention as long as the position information of the second target is stored.

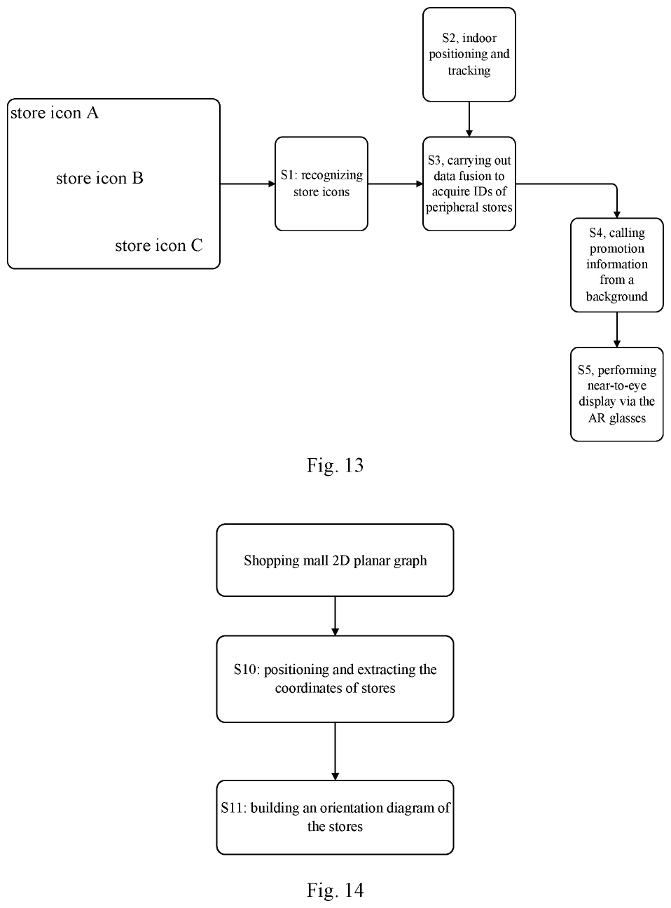

For example, when the indoor place is a shopping mall, operation in the embodiment mentioned above specifically comprises the following steps: firstly, selecting a series of obvious visual scenes/signs as identification objects in the shopping mall according to application requirements; wherein one large category of visual scenes/signs are logos on tops of the stores, identification of such signs enables the camera to identify each store, thereby overlaying (3D) promotion information for each store. For a specific flow example, refer to FIG. 13, i.e., S1: recognizing store icons; S2, indoor positioning and tracking; S3, carrying out data fusion to acquire IDs of peripheral stores; S4, calling promotion information from a background; and S5, performing near-to-eye display via the AR glasses. The step S1 and the step S2 can be carried out in any order, and can also be carried out at the same time. Another large category of visual scenes/signs are some scenes/signs which are easy to identify on walkways of the shopping mall, and identification of such signs can enable the camera to identify an area (such as a women's dress area, a men's dress area or a children's area) of the shopping mall, and then overlay (3D) promotion information related to the area, such as summarized promotion information of stores around the area. For a specific flow example, refer to FIG. 14, i.e., S10: positioning and extracting the coordinates of stores; and S11, building an orientation diagram of the stores. After the visual identification objects are selected, a data acquisition process is carried out, and the process is mainly used for shooting the selected visual objects from different directions and different angles to construct a visual database. An algorithm is then established to distinguish and identify the different visual objects. The main principle of the algorithm is that a currently observed image is matched with images in the visual database to find the most matched visual object, and if similarity reaches a certain threshold, the currently observed image is considered as the matched visual object. Because the database comprises information of each direction and angle of the visual object, the algorithm can identify the same visual object from different angles. Relatively long time is consumed by the algorithm in such part, so that power consumption is high, but better positioning accuracy and stability can be brought. By means of a simultaneous localization and mapping (SLAM) technology, identification of the visual objects can help to calculate and restore visual angles (positions and postures) when a consumer sees the visual objects, and therefore vivid 3D information can be overlaid.

According to the implementation mode provided by the embodiment of the present invention, the second targets are determined and then the position information is stored, so that the visual signals can be quickly and conveniently collected, meanwhile, time for calling the visual signals is reduced, fluency in use is improved, and thus user experience is enhanced, and market competitiveness is increased.

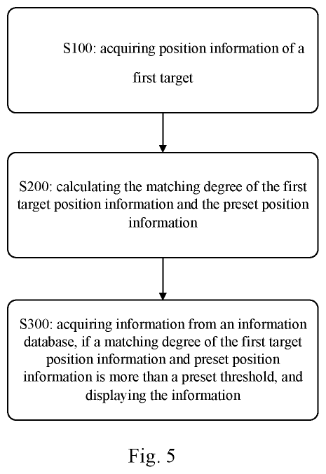

FIG. 5 is the flow block diagram of an indoor augmented reality information display method provided by one embodiment of the present invention. referring to FIG. 5, the indoor augmented information display method provided by the embodiment of the present invention also comprises the following steps: S200: calculating the matching degree of the first target position information and the preset position information.

In the implementation mode provided by the embodiment of the present invention, through calculating the matching degree of the first target position information and the preset position information, the matching degree of the two can be intuitively represented via the value of the matching degree, which is beneficial to judging that whether the matching degree is more than the preset threshold, further increases information display accuracy and improves user experience.

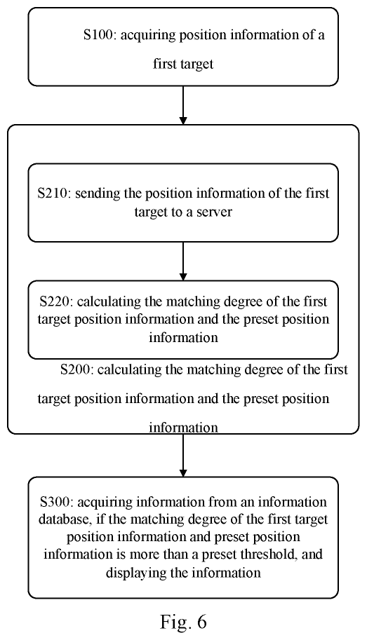

In some embodiments, referring to FIG. 6, the step S200 mentioned above specifically comprises the sub-steps:

S210: sending the position information of the first target to a server,

wherein the preset position information is stored in the server, optionally, the preset position information is stored in advance, and optionally, the preset position information is updated in real time and stored.

In some embodiments, the amount of preset position information is the same as that of the position information parameter entries included in the first target position information. In some embodiments, the amount of preset position information is more than that of the information parameter entries included in the first target position information. It should be understood by those skilled in the art, the amount of the preset position information should be at least the same as that of the information parameter entries included in the first target position information, and the position should also be represented when the number of the first target information parameter entries is minimum.

It should be understood by those skilled in the art, transmission may be in response to a server requesting a transmission instruction, or may be active, and as long as information transmission is built between the two components and the server receives the position information of the first target, it should be within the scope of protection of the present invention.

S220: calculating the matching degree of the first target position information and the preset position information,

wherein calculation of the matching degree of the two pieces of position information can be that the final matching degree is acquired by carrying out weighted calculation on the matching degrees of the same parameters in the position information, or the final matching degree can be directly acquired by selecting the specific parameter in the position information. The matching degree capable of representing the two pieces of position information should be within the scope of protection of the present invention.

Since the method provided by the embodiment is adopted, through sending the position information of the first target to the server, and calculating the matching degree in the server, the requirement of the terminal for operation can be lowered, and thus the problem that installation space of the terminal becomes large due to the requirement of an operation module is solved, namely, the terminal equipment becomes smaller and more exquisite, the terminal equipment is convenient to carry, and the user experience is improved.

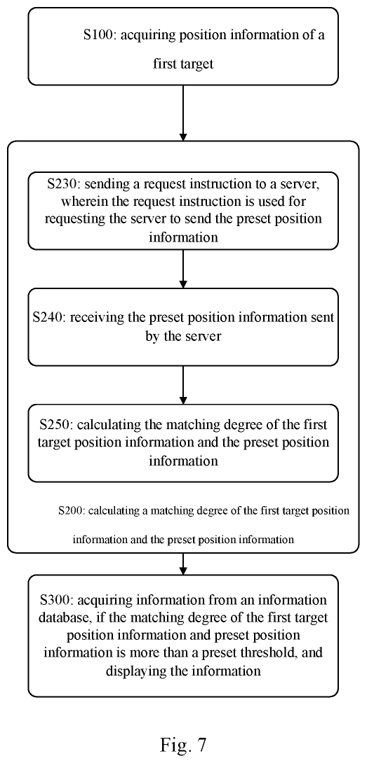

In some embodiments, referring to FIG. 7, the step S200 mentioned above specifically comprises the sub-steps:

S230: sending a request instruction to a server, wherein the request instruction is used for requesting the server to send the preset position information,

S240: receiving the preset position information sent by the server, and

S250: calculating the matching degree of the first target position information and the preset position information.

The method provided by this embodiment is adopted, and the preset position information is received through requesting the server, so that the requirement of the terminal on memory can be reduced, and thus the phenomenon that function collapse of the terminal occurs due to insufficient memory is avoided, the failure rate of the terminal is reduced, and the user experience is enhanced.

S300: acquiring information from an information database, if a matching degree of the first target position information and preset position information is more than a preset threshold, and displaying the information.

It should be understood by those skilled in the art, optionally, the preset position information is the position information stored in advance, and optionally, the preset position information is downloaded from the corresponding server in real time according to the position information of the first target.

Information display refers to display of augmented reality information, optionally, the information is introduction of the indoor scene, optionally, the information is introduction of indoor objects, and optionally, the information is indoor messages. For example, when the indoor place is a shopping mall, the information may be introduction of stores in the shopping mall, introduction of commodities in the stores, promotion information in the stores, and other messages in the stores.

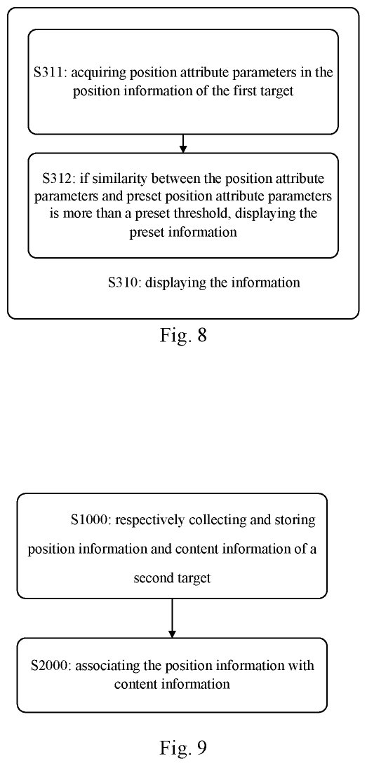

FIG. 8 is the flow block diagram of an indoor augmented reality information display method provided by one embodiment of the present invention. Referring to FIG. 8, the step S310: displaying the information provided by the embodiment of the present invention comprises the following sub-steps:

S311: acquiring position attribute parameters in the position information of the first target, wherein position attributes refer to attribute information related to the position, and in some embodiments, the position attribute parameters are longitude and latitude of the position, and in some other embodiments, the position attribute parameters are the degrees of included angles between the first target and the different axes in a space coordinate system. It should be understood by those skilled in the art, as long as the position attributes can represent the first target, it should be within the scope of protection of the present invention, no matter the position attributes are longitude and latitude or the degrees of the included angles.

S312: if similarity between the position attribute parameters and preset position attribute parameters is more than a preset threshold, displaying the preset information,

wherein the similarity can be a similar result acquired by performing similarity calculation on a certain attribute in the position attributes, can also be a similarity result acquired by performing similarity calculation on a plurality of attributes in the position attributes and then performing weighted calculation, and can certainly be a similarity result acquired by performing similarity calculation on all attributes in the position attributes and then performing calculation again.

The preset information refers to coordinate information of each collection point, which is acquired through mapping the place to be subjected to data collection by an simultaneous localization and mapping (SLAM) technology in advance; and a corresponding relation between the collection point and the coordinate information thereof is pre-established and stored. Furthermore, a visual-inertial odometer (VIO for short) technology can be used for mapping the place and acquiring coordinate information of the collection points. The visual-inertial odometer technology is also called a real-time positioning and mapping technology based on the VIO, and is a technology for realizing positioning and mapping by combining information collected by a visual sensor such as a camera and information collected by an inertial sensor such as an inertial measurement unit (IMU for short).

The present invention has outstanding technical effects, for example, when the indoor place is a shopping mall, positioning accuracy is greatly improved by combining multi-path signals (wireless signals, inertial sensing signals on mobile/wearable equipment and visual signals). By means of positioning, the consumer in the shopping mall can be positioned, the visual angle of the consumer watching a scene/commodity can also be positioned, and preparation is made for achieving realistic 3D overlay through the SLAM technology subsequently. In addition, information that consumers and merchants are interested in, such as promotion information and commodity information, can be displayed according to the positioning result, so that shopping experience of the consumers can be enhanced, and attraction and competitiveness of the merchants can be enhanced. In addition, the promotion information can be automatically triggered according to the current scene or position of the consumer, conscious and complex operation of the consumer is omitted, meanwhile, high customization can be achieved, the consumer can have a novel feeling, and sales can be greatly promoted.

It should be understood by those skilled in the art that the preset information is not only promotion information or commodity information, other information can also be displayed to enrich the shopping experience of consumers in shopping mall. For example, a treasure hunting activity, like Pokemon Go, can be performed in a shopping mall, and after a consumer arrives at a certain area (the area is preset but the consumer does not know), or after the consumer sees a certain visual object in the shopping mall (similarly, the visual object is preset by the shopping mall but the consumer does not know) through a mobile phone/AR glasses, some interesting things, such as a Pokemon, a picture, or a game played together, or a video/audio are played to bring a surprise to the consumer. Meanwhile, competition and reward mechanisms can be introduced, the activity participation stickiness of the consumers is improved, the time of the consumers in the shopping mall is prolonged, the popularity of the shopping mall is increased, and thus the sales volume is indirectly increased.

FIG. 9 is a flow block diagram of a method for building an information database provided by one embodiment of the present invention. Referring to FIG. 9, the method for building an information database provided by the embodiment of the present invention comprises the following steps:

S1000: respectively collecting and storing position information and content information of a second target,

wherein the content information refers to introduction of object content, additional information related to the object and the like. For example, when the indoor scene is a shopping mall, the content information may be introduction of stores, introduction of commodities in the stores, or promotion information of the stores. In this embodiment, definition of the second target is the same as that of the second target in FIG. 4.

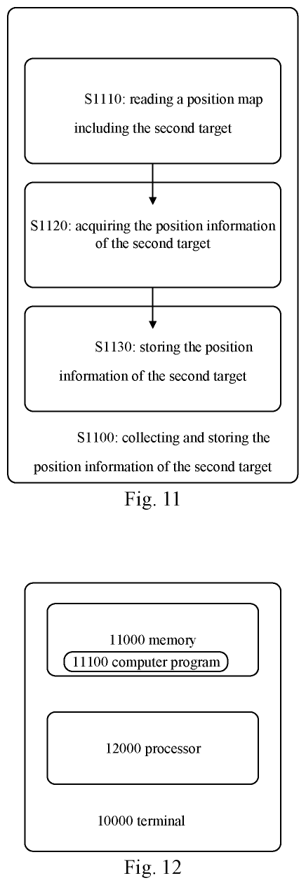

In some embodiments, referring to FIG. 11, the step S1100: collecting and storing the position information of the second target specifically comprises the steps:

S1110: reading a position map including the second target,

wherein the position map refers to a map that can represent a position relation, may be a planar graph or a space diagram, and may also be a design diagram, a CAD graph, a panoramic photo or other proportionally zoomed planar graph or space diagram including the second target;

S1120: acquiring the position information of the second target; and

S1130: storing the position information of the second target.

According to the embodiment of the present invention, the position information is acquired from the position map and stored, so that on the one hand, errors caused by manual measurement in conventional modes are avoided, and thus accuracy of the position information is improved; and on the other hand, the efficiency of acquiring the position information is improved, meanwhile requirements on the type and size of the position map are reduced, and thus the application range is enlarged and the market competitiveness is increased.

S2000: associating the position information with content information, wherein associating refers to building a corresponding relation between the position information and the content information, the corresponding relation may be one-to-one, one-to-many or many-to-many.

It should be understood by those skilled in the art, when the application scene is a shopping mall, and the planar graph/CAD graph of the shopping mall cannot be provided, the corresponding relation between the stores and position information thereof can also be manually established by the way of field survey and mapping and the like to form a database. A front-end interface for managing the database can be displayed in a traditional list form instead of a map/planar graph form, in combination with text descriptions and illustrations, to assist a database manager to establish the corresponding relation between the stores and the position information thereof. This interface, although not as intuitive as the map/planar graph form, is available.

According to the implementation mode provided by the embodiment of the present invention, the user can conveniently manage the content of the indoor information according to own requirements, so that the user flexibility and convenience are improved, and the market competitiveness is improved. According to the present invention, by using image processing and computer vision technologies, when the application scene is a shopping mall, a database for managing geographic information and content information of the shopping mall can be quickly built, so that the deployment time and cost of the whole system are greatly saved, and a way is laid for large-scale popularization of the whole system.

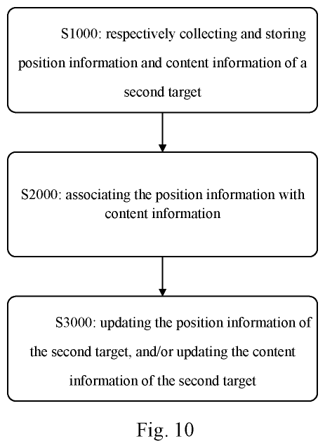

FIG. 10 is the flow block diagram of the method for building the information database provided by one embodiment of the present invention. Referring to FIG. 10, the method for building the information database provided by the embodiment of the present invention also comprises the following step:

S3000: updating the position information of the second target, and/or updating the content information of the second target,

wherein updating refers to correcting or supplementing the position information and/or the content information, thus enabling the information to be corresponding to reality information. For example, when the indoor place is a shopping mall, updating may be updating of store positions in the shopping mall carried out by a shopping mall manager, may be management on various kinds of information in the shopping mall carried out by the shopping mall manager, may be updating of own store position and commodities in the store carried out by a store owner in the shopping mall, may be management on updating of promotion information of the store carried out by the store owner, and may certainly be an error correction application of store position information in the shopping mall carried out by a customer in the shopping mall. In this embodiment, definition of the second target is the same as that of the second target in FIG. 4.

According to the method provided by the embodiment of the present invention, the user can conveniently manage the content of the indoor information according to own requirements, so that the user flexibility and convenience are improved, and the market competitiveness is improved.

The embodiment of the present invention also provides an indoor augmented reality information display system; in some embodiments, the system comprises modules for executing steps of the indoor augmented reality information display method as described in any of embodiments mentioned above.

In some embodiments, the modules of the system at least comprise a wireless positioning module and a visual positioning module,

wherein the wireless positioning module is a positioning module in signal fusion with an inertial sensor in the mobile/wearable equipment based on wireless signals (such as Wifi or Bluetooth signals); and the visual positioning module is a positioning module based on visual scene/sign signals, and the visual positioning module not only can improve positioning accuracy, but also can acquire the observation visual angle of a user in real time through a vision technology. Improvement of the positioning accuracy enables the accurate triggering and pushing of location-based content to be possible. Acquisition of the observation visual angle is the basis of overlaying of realistic 3D content through the SLAM technology. The wireless positioning module is relatively low in positioning accuracy and low in power consumption; and the visual positioning module is relatively high in positioning accuracy, but also high in power consumption. The two modules are combined to form an integral positioning system of which the accuracy is progressively enhanced from coarse to fine. In some embodiments, the wireless signal positioning module in the system may operate all the time (due to low power consumption), and continuously return to the current location. If the current positioning result is large in uncertainty and does not reach the expected positioning accuracy, the visual positioning module is started to carry out correction so as to reach the expected positioning accuracy.

In some embodiments, the system comprises modules for executing steps of the method for building the information database as described in any of embodiments mentioned above.

When the system that comprises the modules for executing steps of the method for building the information database is applied to a shopping mall, we call it a management system in one embodiment. The management system mainly manages two parts of information, one part is geographic information that mainly comprises position information of each store in the shopping mall, position information of commodities in each store and position information of other selected visual scenes/signs (such as posters) in the shopping mall; and the other part is content information including promotion information and commodity information that need to be combined with the corresponding geographic position, so that the content corresponding to the position can be directly called from the database to be displayed on the terminal (smart phone, AR glasses and the like) of the consumer after the positioning system acquires a positioning result. And on the other hand, the database should be convenient for shopping mall managers and operators of the stores to update the content in real time in the background. In order to enable the database manager to clearly correspond geographic information with content information, no matter an internal storage structure of a database or a page presented to the database manager by a front end for updating the content, the geographic information and the content information are in a similar graph structure that can clearly show the relative geographical position relation between stores, instead of a list structure in a traditional relational database, and then update of the database is completed by updating information of different positions in the graph. For example, the update page of our database may be, for example, a web page. The traditional practice may be that all stores are listed in the web page in a list form, the store name of each store is a link, and the database manager clicks the link to enter an update interface corresponding to the store to receive new picture/video/audio and other content information uploaded by the manager. The innovation of the present invention lies in that the web page is no longer a list, but a planar graph of the whole shopping mall, and the position of each store is marked on the planar graph, so that the position information of all the stores is clear immediately. Then, the database manager can skip to the content update interface of the store only through clicking the position of the store to be updated on the planar graph. In addition, the database can store information of different shopping malls independently, and corresponding information can be loaded according to the shopping mall where the consumer is located when in specific use.

In order to show in a graph form, the system quickly measures to acquire the position information and the relative position relation of each store in the large shopping mall by using image processing and computer vision technologies. In some embodiments, the image processing and computer vision technologies are an OCR (Optical Character identification) technology and an image segmentation technology to automatically read the information of a planar graph/CAD (Computer-Aided Design) graph of a shopping mall, acquire a store list and a geographic position (see FIG. 3) corresponding to each store, and change the store list and each geographic position into a programmable, clickable and operable object, thereby being conveniently presented to the database manager.

In some other embodiments, the system comprises the module for performing steps of the indoor augmented reality information display method as described in any of embodiments mentioned above, and the module for performing steps of the method for building the information database as described in any of the embodiments mentioned above.

The embodiments provided by the present invention have outstanding technical effects, for example, when the indoor place is a shopping mall, the management system provided by the present invention can perform efficient management on large-scale merchant promotion information. In the era of pursuing personality increasingly, accurate and customized advertisement can motivate the mind of the consumers more. Through the mobile equipment or the wearable equipment, the advertisement information can be conveniently pushed to the consumers at low cost, so that rapid updating and customized accurate pushing of advertisements become possible (at present, many stores still hang promotion information beside in the form of huge posters, and the posters are high in cost and long in manufacturing period, so that the stores are difficult to rapidly update the advertisements and promotion information, and the advertisements cannot be customized for different consumers). The management system provided by the present invention can efficiently and conveniently manage the advertisement promotion information and the position information of each store in the large shopping mall and enable the information to be corresponding, is combined with the front-end smart phone/AR glasses of the consumer, to display the corresponding content according to the positioning result. By using image processing and computer vision technologies, the information can be automatically extracted from the planar graph/CAD graph of the shopping mall, and the corresponding relation between names and geographic positions of the stores can be established. And then through the efficient database system and communication system, the effects of updating the advertisements and promotion information on the back end in real time and displaying the advertisements and promotion information on the front end of the consumer in real time are achieved. And the positioning result and the promotion content of the store are combined, so that the win-win effects of improving the shopping experience of the consumer and improving the popularity and sales volume of the store are achieved.

It should be understood by those skilled in the art that the front end of database management can be a website or a mobile phone APP, so that the database manager can update the content information of shopping malls and stores in real time by using various kinds of equipment at any time and any place.

In addition, the system provided by the present invention is illustrated from a consumer perspective:

the specific use scene of the consumer is as follows: when the consumer walks close to a shopping mall and opens an APP (for example, if the consumer is in the scene of glasses, the glasses can be automatically opened instead of the APP); which shopping mall the consumer walks in is determined according to GPS information or the wireless signal positioning system, and then information of the corresponding shopping mall is loaded from the remote database. Loading may refer to being downloaded to the consumer's equipment, and may also refer to only telling the remote database that the request of the equipment is only queried from the mall without being downloaded. Then the consumer shops in the shopping mall, and the equipment of the consumer can be positioned in real time. When the location where the promotion content information or other information is displayed is positioned, the corresponding content can be automatically called from the database to be displayed on the mobile phone or glasses of the consumer, and thus whole user experience is completed. Calling may refer to local reading from the equipment (if the content of the database has been pre-loaded) or may refer to a network request sent to the database.

It should be understood by those skilled in the art, the system provided by the present invention has the sane beneficial effects as the embodiments mentioned above, which are not repeated here.

The embodiment of the present invention also provides a computer readable storage medium in which a computer program 11100 is stored, and when the program is executed by a processor 12000, steps of the method as described in any of the embodiments mentioned above are implemented. The computer readable storage medium may include, but is not limited to, disks of any type, comprising a floppy disk, an optical disk, DVD, CD-ROM, a micro driver, a magneto-optical disk, ROM, RAM, EPROM, EEPROM, DRAM, VRAM, flash memory 11000 equipment, a magnetic card or an optical card, a nanometer system (comprising a molecular memory 11000IC), or any type of medium or equipment applicable to storing instructions and/or data. A specific execution process can refer to specific description of the method provided by the embodiments, and is not repeated here.

The embodiment of the present invention also provides a terminal 10000 comprising a memory 11000, a processor 12000 and a computer program 11100 that is stored in the memory 11000 and can run on the processor 12000, wherein when the processor 12000 executes the computer program 11100, the indoor augmented reality information display method as described in any of embodiments mentioned above is implemented.

In some embodiments, wherein when the processor 12000 executes the computer program 11100, the method for building the information database as described in any of embodiments mentioned above is implemented.

In some other embodiments, wherein when the processor 12000 executes the computer program 11100, the indoor augmented reality information display method as described in any of embodiments mentioned above can be implemented, and the method for building the information database as described in any of embodiments mentioned above can also be implemented. A specific execution process can refer to specific description of the method provided by the embodiments, and is not repeated here.

In the embodiments of the present invention, the processor 12000 as a control center of the computer system, may be the processor 12000 of a physical machine, and may also be the processor 12000 of a virtual machine. In the embodiments of the present invention, at least one instruction is stored in the memory 11000, and the instruction is loaded and executed by the processor 12000 to implement the method in each embodiment.

The terminal in the embodiments of the present invention may include, but is not limited to, the device with a display function, such as a smart phone, a tablet personal computer, a palm computer, a personal digital assistant (PAD) and an interactive smart tablet personal computer, augmented reality glasses (otherwise known as AR glasses, smart glasses) or other augmented reality equipment (otherwise known as AR equipment), virtual reality equipment (otherwise known as AR equipment), a mobile computer, a smart phone, a smart watch or other wearable equipment, a navigation device, or other equipment capable of collecting position information data.

In another embodiment of the present invention, the processor 12000 may comprise one or more processing cores, such as a four-core processor 12000 and an eight-core processor 12000. The processor 12000 may be implemented by using at least one of hardware forms, such as digital signal processing (DSP), a field-programmable gate array (FPGA) and a programmable logic array (PLA). The processor 12000 may also comprise a main processor 12000 and an auxiliary processor 12000, wherein the main processor 12000 is the processor 12000 for processing data in a wake-up state, and also called a central processing unit (CPU); and the auxiliary processor 12000 is a low power consumption processor 12000 for processing data in a stand-by state.

The memory 11000 may comprise one or more computer readable storage mediums that may be non-transient. The memory 11000 may also comprise a high speed random access memory 11000, and a non-volatile memory 11000, such as one or more pieces of magnetic disk storage equipment and flash memory equipment. In some embodiments of the present invention, the non-transient computer readable storage medium in the memory 11000 is used for storing at least one instruction that is used for being executed by the processor 12000 to implement the methods provided by the embodiments of the present invention.

The foregoing description is intended only as preferred embodiments of the present invention and is not intended to limit the present invention in any way; although the present invention has been disclosed above with preferred embodiments, the embodiments are not intended to limit the present invention; some alterations or modifications to equivalent embodiments can be made by those skilled in the art through using the technical content disclosed above, without departing from the scope of the technical solutions of the present invention; and any simple modifications, equivalent changes, and modifications to the above-mentioned embodiments made in accordance with the technical essence of the present invention without departing from the scope of the technical solutions of the present invention still remain within the scope of the technical solutions of the present invention.

What is claimed:

1. An indoor augmented reality information display method wherein the method comprises the following steps:
acquiring position information of a first target; and
acquiring information from an information database, if a matching degree of the first target position information and preset position information is more than a preset threshold, and displaying the information.

2. The indoor augmented reality information display method of claim 1, wherein the step of acquiring the position information of the first target comprises the sub-steps:
collecting first signals within a preset range of the first target; and
if the first signals meet a first condition, determining the position information of the first target.

3. The indoor augmented reality information display method of claim 2, wherein the step of collecting the first signals within the preset range of the first target adopts a wireless signal fingerprint method, and when building a map, the wireless signal fingerprint method comprises the steps:
performing data collection and system deployment within a preset range; and
calculating to acquire position information within the preset range;
wherein the data collection and system deployment adopt a robot-based mode or a crowdsourcing-based mode.

4. The indoor augmented reality information display method of claim 2, wherein when the first signals do not meet the first condition, second signals within the preset range of the first target are collected;
wherein the position information of the first target is determined after the second signals are fused with the first signals.

5. The indoor augmented reality information display method of claim 4, wherein,
the first signals are wireless signals, and the second signals are visual signals; or
the first signals are visual signals, and the second signals are wireless signals.

6. The indoor augmented reality information display method of claim 5, wherein,
the step of collecting the visual signals within the preset range of the first target comprises the sub-steps:
determining a second target within the preset range; and
storing position information of the second target,
wherein the position information of the second target comprises at least one of a relative distance and a relative angle between the second target and the first target.

7. The indoor augmented reality information display method of claim 5, wherein,
the wireless signals are at least one kind of the following signals:
Wireless Fidelity signal, Bluetooth signals and inertial sensor signals.

8. The indoor augmented reality information display method of claim 5, wherein,
the visual signals are visual scene signals and/or sign signals.

9. The indoor augmented reality information display method of claim 1, wherein, the method also comprises the step of calculating the matching degree of the first target position information and the preset position information, before the step of acquiring the information from an information database, if the matching degree of the first target position information and preset position information is more than the preset threshold, and displaying the information.

10. The indoor augmented reality information display method of claim 9,
wherein, the step of calculating the matching degree of the first target position information and the preset position information comprises the sub-steps:
sending the first target position information to a server, and
calculating the matching degree of the first target position information and the preset position information; or
the step of calculating the matching degree of the first target position information and the preset position information comprises the sub-steps:
sending a request instruction to a server, wherein the request instruction is used for requesting the server to send the preset position information,
receiving the preset position information sent by the server, and
calculating the matching degree of the first target position information and the preset position information.

11. The indoor augmented reality information display method of claim 1, wherein, the step of displaying the information comprises the sub-steps:
acquiring a position attribute parameter in the first target position information; and
if similarity between the position attribute parameter and a preset position attribute parameter is more than a threshold, displaying the preset information.

12. The indoor augmented reality information display method of claim 11, wherein, the position attribute parameter comprises:
a three-dimensional coordinate value of the first target; and/or
the degrees of included angles between the first target and three-dimensional space coordinate axes,
wherein the position attribute parameter and the preset position attribute parameter adopt a same coordinate system.

13. The indoor augmented reality information display method of claim 1, wherein, the first target is augmented reality glasses.

14. A method for building an information database, comprising the steps:
respectively collecting and storing position information and content information of a second target; and
associating the position information with the content information.

15. The method for building the information database of claim 14, wherein, after the step of associating the position information with the content information, the method further comprises the steps:
updating the position information of the second target; and/or
updating the content information of the second target.

16. The method for building the information database of claim 14, wherein, the step of collecting and storing the position information of the second target comprises the sub-steps:
reading a position map including the second target;
acquiring the position information of the second target; and
storing the position information of the second target;
wherein the position information of the second target is editable after being stored.

17-19. (canceled)
